(19) United States
(12) Patent Application Publication
(10) Pub. No.: US 2009/0296525 A1
(43) Pub. Date: Dec. 3, 2009

(54) NOISE SUPPRESSION FOR DETECTION AND LOCATION OF MICROSEISMIC EVENTS USING A MATCHED FILTER

(76) Inventors: Leo Eisner, Prague (CZ); David Abbott, Highlands Ranch, CO (US); William B. Barker, Houston, TX (US); James Lakings, Houston, TX (US); Michael P. Thornton, Houston, TX (US)

Correspondence Address: RICHARD A. FAGIN, P.O. BOX 1247, RICHMOND, TX, 77406-1247, US

(21) Appl. No.: 12/127,205

(22) Filed: May 27, 2008

(51) Int. Cl. G01V 1/36

(52) U.S. Cl. 367/41

(57) ABSTRACT

A method for determining presence of seismic events in seismic signals includes determining presence of at least one seismic event in seismic signals corresponding to each of a plurality of seismic sensors. A correlation window is selected for each of the plurality of seismic signals. Each correlation window has a selected time interval including an arrival time of the at least one seismic event in each seismic signal. Each window is correlated to the respective seismic signal between a first selected time and a second selected time. Presence of at least one other seismic event in the seismic signals from a result of the correlating.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The invention relates generally to the field of imaging the Earth's subsurface using passive seismic detection techniques. More specifically, the invention relates to processing methods for passive seismic signals to improve the ability to detect subsurface seismic events from such signals.

2. Background Art

Passive seismic emission tomography is a process in which an array of seismic sensors is deployed in a selected pattern on or near the Earth's surface (or on or near the water bottom in marine surveys and in wellbores drilled through subsurface formations) and seismic energy is detected at the sensors that emanates from various seismic events occurring within the Earth's subsurface. Processing the signals detected by the sensors is used to determine, among other things, the position in the Earth's subsurface and the time at which the various seismic events took place.

Applications for passive seismic emission tomography include, for example, determining the point of origin of microearthquakes caused by movement along geologic faults (breaks in rock layers or formations), movement of fluid in subsurface reservoirs, activation of natural faults, casing failure, reservoir compaction, sealing faults, and monitoring of movement of proppant-filled fluid injected into subsurface reservoirs to increase the effective wellbore radius of wellbores drilled through hydrocarbon-producing subsurface Earth formations (“fracturing”). The latter application, known as “frac monitoring” is intended to enable the wellbore operator to determine, with respect to time, the direction and velocity at which the proppant filled fluid moves through particular subsurface Earth formations.

Passive seismic emission tomography for the above types of interpretation includes determining what are seismic-induced events from within the signals detected at each of the seismic sensors, and for each event detected at the seismic sensors, determining the spatial position and time of the origin of the seismic event. Passive seismic interpretation methods known in the art are undergoing continuous improvement to better resolve the source of seismic events originating from the Earth's subsurface. There continues to be a need for improved methods of passive seismic emission tomography.

### SUMMARY OF THE INVENTION

A method for determining presence of seismic events in seismic signals according to one aspect of the invention includes determining presence of at least one seismic event in seismic signals corresponding to each of a plurality of seismic sensors. A correlation window is selected for each of the plurality of seismic signals. Each correlation window has a selected time interval including an arrival time of the at least one seismic event in each seismic signal. Each window is correlated to the respective seismic signal between a first selected time and a second selected time. Presence of at least one other seismic event in the seismic signals from a result of the correlating.

Other aspects and advantages of the invention will be apparent from the following description and the appended claims.

### BRIEF DESCRIPTION OF THE DRAWINGS

FIG. 1 shows an example array of seismic sensors disposed above a portion of the subsurface to be surveyed using passive seismic signals.

FIG. 2A shows an example of a master seismic event in passive seismic signals.

FIG. 2B shows an example of the data in FIG. 2A subjected to filtering.

FIG. 3 shows an example of slave events detected in the data of FIG. 2A using a cross-correlation technique according to the invention.

FIG. 4 shows a flow chart of an example process according to the invention.

### DETAILED DESCRIPTION

In methods according to the invention, seismic events originating in the Earth's subsurface may be identified and their spatial origin and time of origin may be determined. Such seismic events may be naturally occurring, or may be induced by performing certain activities on subsurface formations. Recording seismic signals related to such subsurface origin seismic events is known as “passive” seismic surveying.

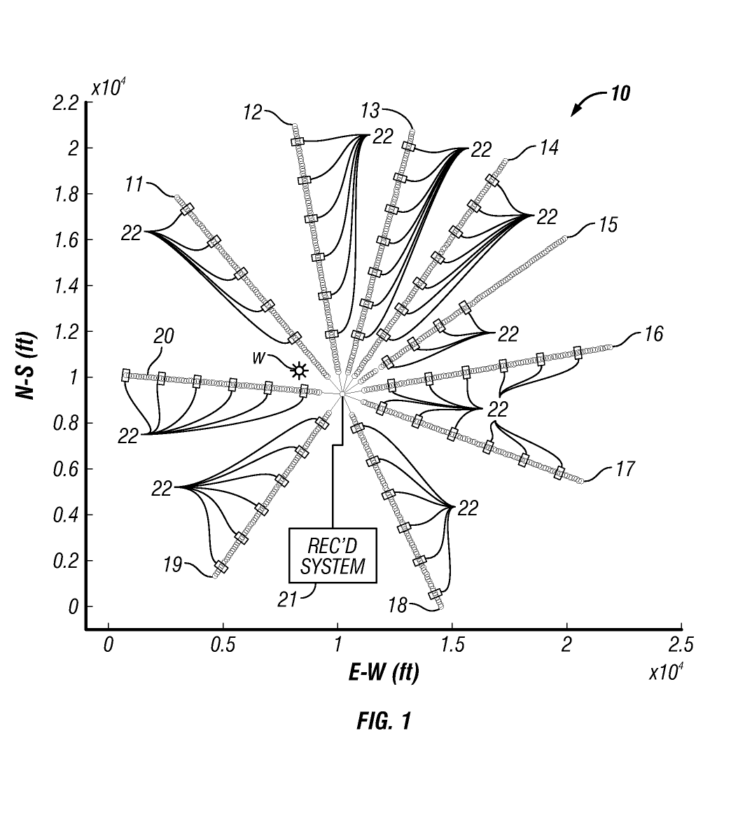

Passive seismic signals may be acquired for processing according to the invention using an array of seismic sensors such as shown in FIG. 1. The array shown in FIG. 1 generally at 10 includes radially extending lines 11 through 20 of spaced apart seismic sensors, individual examples of which are shown at 22, such as single component or multi-component geophones, accelerometers or other particle motion sensors. The array 10 shown in FIG. 1 is configured and used, in some examples, as part of a fracture monitoring service sold under the trademark FRACSTAR, which is a registered trademark of Microseismic, Inc., Houston, Tex., the assignee of the present invention. In such monitoring service, seismic signals are detected while fluid is pumped into a subsurface formation from the surface through a wellbore W drilled through the subsurface formations. See, for example, U.S. Patent Application Publication No. 2008/0068928 filed by Duncan et al., and the patent application for which is assigned to the assignee of the present invention for a description of fracture monitoring using passive seismic signals.

The arrangement of the array 10 shown in FIG. 1, however, is only one example of an arrangement of seismic sensors that may be used to acquire passive seismic signals according to the invention, and such arrangement should not be construed as a limit on the scope of the present invention. The invention is also not limited in scope to use with fracture monitoring, but may be used with any type of passive seismic surveying. For example, seismic surveys according to the invention may be conducted on land or on the bottom of a body of water. Surveys may also be conducted with seismic sensors deployed in a wellbore drilled through subsurface formations or a mine. If an array of seismic sensors is disposed on the bottom of a body of water, for example, the seismic sensors may include or be substituted by hydrophones or similar sensor that is responsive to pressure or the time gradient of pressure. Wellbore sensors may include either or both particle motion responsive sensors and pressure responsive sensors. See, for example, U.S. Pat. No. 4,715,469 issued to Yasuda et al. for an example of a wellbore sensor system.

A recording system 21 disposed proximate the array 10 may include equipment for (not shown separately) to be used to record the signals generated by the seismic sensors in each of the sensor lines 11-20. The signals may be recorded individually for each sensor 22, or in some examples, selected numbers of adjacent seismic sensors in each line 11-20 may have their signals combined or summed by electrical series connection or other electrical configuration, or the signals may be equivalently summed in the recording system 21. The recording system 21 may include a general purpose, programmable computer (not shown separately) for processing the recorded signals, including according to the invention. Processing signal recordings according to the invention may be also performed at any other location.

Recording seismic signals generated by the sensors 22 in the array 10 may be performed continuously over a selected period of time, for example from several minutes to several weeks in duration. In other examples, signal recording may take place over a time period extending as long as several years in duration. Thus, for each sensor (or selected groups of sensors) a signal recording will include signal amplitude with respect to time for the entire selected recording time interval.

In a method according to the invention, all or a selected subset of the recorded seismic signals may be scanned to detect one or more events that may be reasonably inferred to be of seismic origin. Such scanning may include identifying signal amplitudes in the recorded signals that, for example, exceed a selected threshold (amplitude peaks). When one or more of such events are detected in a plurality of the recorded signals, the time of arrival of each such event in each recorded signal is determined in order to establish that the events are possibly of seismic origin. One technique for determining whether the identified amplitude peaks may be of seismic origin is to determine whether the arrival times of such peaks at each seismic sensor correspond to normal moveout, which is a relationship between event arrival time at the sensors and distance from the source of the event and the particular sensor that detected the seismic energy from the event. As will be appreciated by those skilled in the art, determining whether the event arrival times correspond to normal moveout will depend in part on the spatial distribution of seismic velocity in the subsurface and the positions of the seismic sensors 22.

Once a particular event has been so identified in the seismic signals, it may be characterized for purposes of the method as a “master” seismic event. For each such master seismic event, a selected correlation “window” may be established. Typically such correlation window will be a time subset of the recorded seismic signals from each sensor, typically within a time interval on the order of one to three hundred milliseconds duration, and such window may be centered in time at the time of the amplitude peak identified as a master seismic event. Thus, the correlation window may contain a portion of the recorded seismic signal from about 50 milliseconds to 150 milliseconds before the amplitude peak, the amplitude peak, and between 50 milliseconds and 150 milliseconds of recorded seismic signal after the amplitude peak. The time window lengths may wary according to the duration of the seismic signal observed in the particular set of recorded seismic signals.

The foregoing correlation window is then correlated with the seismic sensor signal recording from which it was taken. Correlation using the correlation window may begin at a first selected time and may end at a second selected time. The first and second selected times may correspond to the beginning and end of signal recording for the particular seismic sensor signal, or they may correspond to one or more time subsets of the entire recorded signal. An output of the correlation will be an amplitude, with respect to time, that represents the degree of similarity between the signals in the correlation window and a corresponding signal to noise ratio in the selected time windows of the recoded signals. Time values for the correlation output will be within a range beginning at the peak arrival recording time less the first selected time, extending to the peak arrival time less the second arrival time.

The foregoing correlation procedure may then be repeated for the master seismic event identified in others of the recorded signals. Note that each correlation is performed by selecting a correlation window from each selected recorded signal, and applying the respective correlation window to the recorded signal from which the window was selected. In the case of multi-component geophones used as the sensors, the correlation should be performed using a correlation window taken from the signal recording of the particular component signal being processed. Processing the seismic signals by such correlation will improve the ability to identify “slave seismic events”, meaning those seismic events that are closely related to the master event in spatial origin and mechanism by which the seismic event is generated.

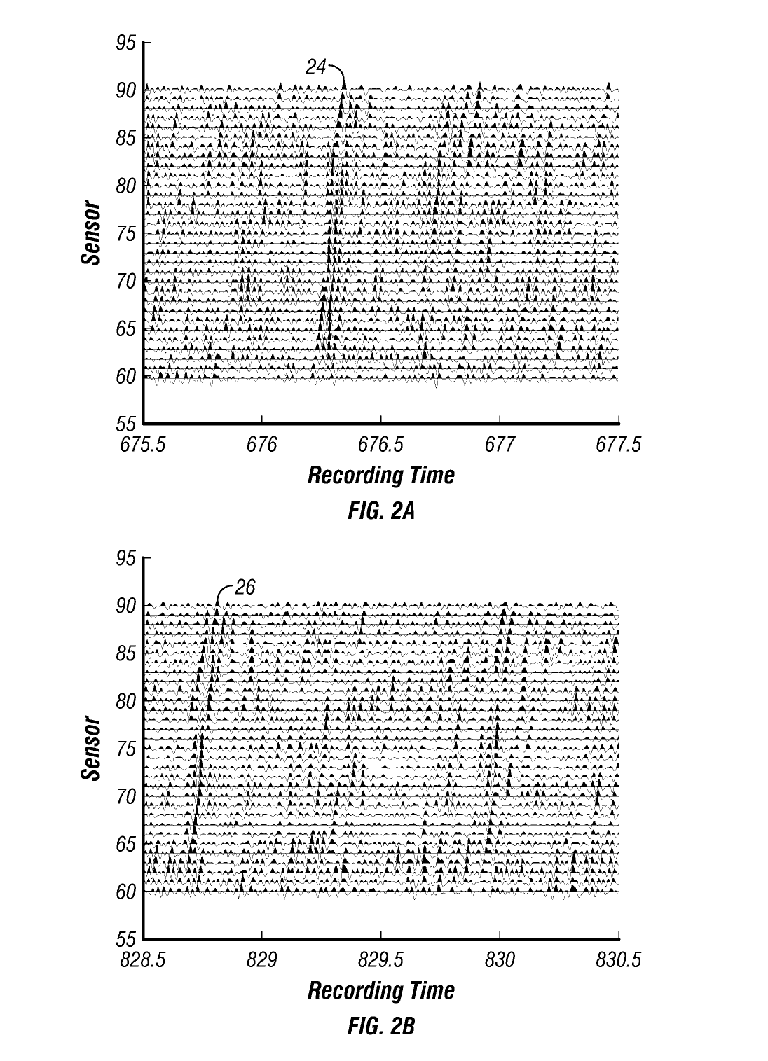

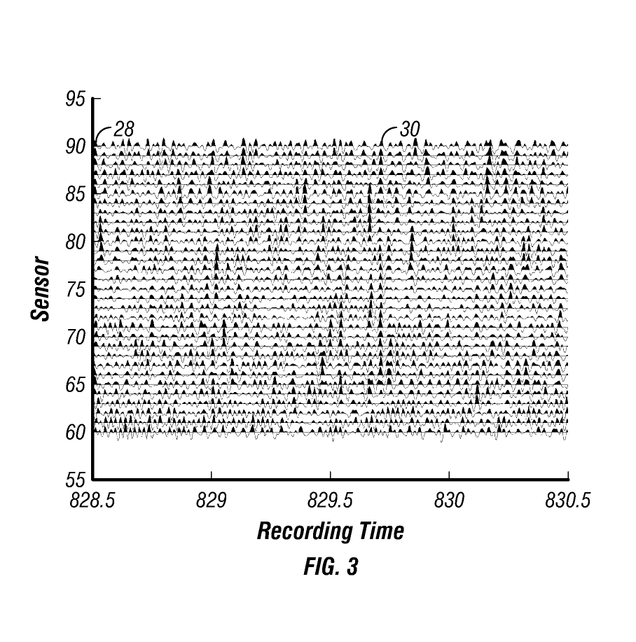

The result of the correlation may remove phase character of the master seismic event that affects slave seismic events in the same recorded signal, thus increasing the signal to noise ratio of the slave seismic events in the recorded seismic signal. The correlation may also reduce the effect of time moveout of the seismic signal between the spatial origin of the seismic event and each sensor in the array. Correlation may also reduce the effect of the nature of the seismic source energy and the effects of the geologic formations between the source and each particular receiver (referred to as the Earth filter). Examples of performing the above procedure will be further explained below with reference to FIGS. 2A, 2B and 3.

An explanation of the theory of processing seismic signals as explained above follows. The particular explanation is related to particle motion seismic sensors, however the general principle is applicable to other types of seismic sensors. Seismic data observed at any seismic sensor can be described as a convolution of the particle motion of the seismic source, the seismic response (including transmission characteristics of the media through which the seismic energy travels from the source to the sensor), and the seismic sensor response to imparted particle motion. Such convolution may be represented by the expression:

D(t)=S(t) [symbol] G(t) [symbol] R(t) (1)

in which t is time, D(t) is the seismic data observed or recorded with respect to time, S(t) is the seismic energy source characteristic with respect to time, G(t) is medium or subsurface response (which may be the linear sum of Green's functions), R(t) is sensor response function and [symbol] represents convolution in the time domain. Note that the source function, S(t) and the subsurface response G(t) are tensors of the second and fourth order, and that equation (1) represents a dyadic product of these two tensors.

In passive seismic signal measuring it can be assumed that the seismic energy source characteristic with respect to time S(t) is a delta function. Furthermore, for seismic events in the subsurface that originate relatively near to each other with respect to the distance between the origin of such events and the sensor positions (called “spatially related” seismic events), and for subsets of the seismic sensors that are relatively closely spaced to each other, the sensor response function R(t) and the media response function (Earth filter) G(t) are similar for such events and such sensors. Finally, if the seismic energy source mechanisms for discrete seismic events are similar to each other (events being “related in mechanism of origin”), the source function S in equation (1) may be characterized as producing two similar time dependent waveforms:

D₁(t)=S₁·G₁ [symbol] R₁(t)≈D₂(t+τ)=S₂·G₂(t+Σ) [symbol] R₂(t+τ) (2)

where τ is the time delay between seismic events 1 and 2, and the parameter subscripts in equation (2) indicate the respective seismic events. To use equation (2) it is possible to cross-correlate recorded seismic signals corresponding to what may be identified as a “master” seismic event in the recorded seismic signals. Such cross correlation may provide a good signal-to-noise ratio estimate of D₁ even in noisy recordings. If signals from a second or further seismic event that satisfies equation (2) are present in such recordings, cross-correlation of two similar signals using the window technique explained above will generate a high correlation result for such second or further seismic events, and such result may be identified as one or more “slave” seismic events. However, if the recordings contain only noise or seismic events with different fundamental characteristics, then the correlation result will be relatively low, especially if stacked over many receivers (i.e. very many realizations of random cross-correlation coefficient). Furthermore, if equation (2) is satisfied, the correlation function will have a peak value at nearly the same time in all sensors in the sensor configuration. Thus, a high value of stacked crosscorrelation from all sensors indicates detection of a slave seismic event, similar to a master seismic event. Such events are also known as “doublets” in earthquake seismology.

A correlation of two similar signals enhances the signal-to-noise ratio of the scattered energy. The seismic source energy is scattered over a time window by the medium (Earth filter) response and the sensor response (G(t) and R(t) in equation (1)). Correlation of master and slave seismic events that satisfy equation (2) represents a sum of squares of the scattered arrivals all contributing to the peak amplitude of the correlation coefficient. The correlation as described above is a scalar product of the time vectors between the window centered around the master seismic event and the window taken from the continuous seismic signal sample.

The above technique has been applied to data from a hydraulic fracture monitoring procedure where the hydraulic fracture was stimulated in several stages of horizontal treatment in a well at a depth of approximately 12,000 ft (3,600 m). Six stages of slurry with a proppant were injected into a shale formation. The present example investigated the initial 15 minutes of the final, sixth stage of slurry pumping, which reactivated a previously stimulated part of a low permeability subsurface gas reservoir. It was possible to detect and locate several hundred seismic events with the stacking of 935 receivers above the reservoir in the vicinity of an injection point close to the left most line 20 of sensors shown in FIG. 1. Initially, one strong master seismic event was observed during the first 15 minutes of fracturing. FIGS. 2A and 2B show waveforms of recorded signals processed using noise suppression of the strongest events detected during stage 6 of the previously described hydraulic fracture stimulation. Note that the waveforms show long reverberations, believed to be caused by energy path and receiver effects, and which last at least 0.4 seconds. Also note that a first signal arrival, shown at 24, is relatively impulsive, indicating a sharp onset of a master event. The move-out shown in the signals is consistent with a seismic source located at approximately the depth of the fracture fluid injection (i.e. 12,000 ft).

Because the signal-to-noise appears relatively good for this “master” event, it may be identified as a master event (D₁) in equation (2). Next, the signals were processed by cross-correlating a 0.4 second (400 millisecond) time window centered around the master event over the entire 15 minutes of data recorded during the fracture monitoring procedure. FIG. 3 shows the cross-correlations of the master event of FIG. 2A with 3 seconds of the time windows around the slave events (e.g., at 26) shown in FIG. 2B. Note the high correlation for the times around 828.5 and 829.6 seconds. These high cross-correlations correspond to two strong slave seismic events, 28 and 30, that are barely visible in FIG. 2B. Note that there is virtually no move-out of the peak of the cross-correlations in FIG. 3 because the spatial origin of the master event and the slave events are essentially the same. It should be noted that the cross-correlations shown in FIG. 3 removed the move-out without any knowledge of the velocity structure, just by satisfying equation (2). If there is move-out in any identified slave events, it can be further used by stacking the cross-correlations for different move-outs each of which corresponds to a different location of the origin of such slave events. The location with highest stacked cross correlation may be used to identify the point of origin of a slave event.

To find all slave events which correlate with negligible move-out (negligible relative to the sample time interval of 0.004 sec), it is possible then to stack the correlated traces for the signals wherein the master event has a good signal-to-noise ratio. Stacking additional signals further improves detection of weak events as long as the master event has a good signal-to-noise ratio on the respective data traces.

After master and slave events have been identified as explained above, the spatial origin (and time of origin) of each such event may be determined. One technique for determining origin of seismic events in passive seismic signals is described in U.S. Patent Application Publication No. 2008/0068928 filed by Duncan et al., and the patent application for which is assigned to the assignee of the present invention. Another technique for determining spatial origin is called travel time tomography. One such technique is described in, W. H. K. Lee and S. W. Stewart, Principles and Applications of Microearthquake Networks, Advances in Geophysics, Supplement 2, Academic Press (1981).

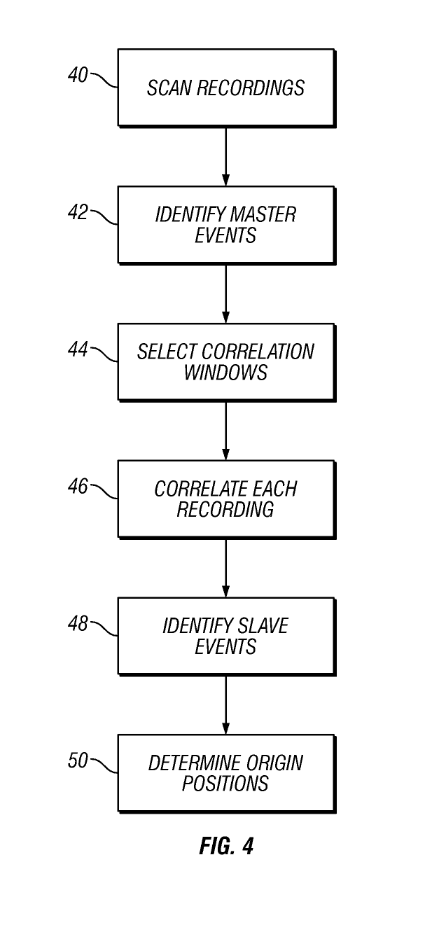

FIG. 4 shows a flow chart of an example process. At 40, signal recordings (traces) from selected ones of the sensors, and/or summed groups thereof are scanned to identify master events at 42. As explained above, identification of master events may include detection of events above a selected amplitude threshold that satisfy normal moveout. At 44, a correlation window is selected for each signal or trace to be processed. At 46, the correlation window is correlated with the data trace from which the window is selected. Such correlation may be performed on selected traces or all available traces in a data set. At 48, slave events may be identified in the correlation output. At 50, the arrival times of the slave events in each trace may be used to identify the spatial origin of the slave events

Methods of processing seismic signals according to the invention may provide better capability to identify spatially and mechanically related seismic events originating in the Earth's subsurface than is possible using processing methods known in the art prior to the present invention. Such identification may make possible more accurate evaluation of subsurface geologic processes, such as fluid movement in subsurface formations, detecting perforation taking place within a casing, casing collapse, and subsidence of formations caused by fluid withdrawal as not limiting examples.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A method for determining presence of seismic events in seismic signals, comprising:
determining presence of at least one seismic event in seismic signals corresponding to each of a plurality of seismic sensors;
selecting a correlation window from each of the plurality of seismic signals, each correlation window having a selected time interval including an arrival time of the at least one seismic event in each seismic signal;
correlating each window to the respective seismic signal between a first selected time and a second selected time; and
determining presence of at least one other seismic event in the seismic signals from a result of the correlating.

2. The method of claim 1 wherein the determining presence of the at least one seismic event comprises selecting signal amplitude above a selected threshold in each of the seismic signals and determining whether arrival time of events above the selected threshold correspond to normal moveout of seismic energy.

3. The method of claim 1 further comprising determining a spatial origin of the at least one seismic event and the at least one other seismic event.

4. The method of claim 1 further comprising determining a time of origin of the at least one seismic event and the at least one other seismic event.

5. The method of claim 1 wherein the at least one seismic event and the at least one other seismic event are spatially related.

6. The method of claim 1 wherein the at least one seismic event and the at least one other seismic event are related in mechanism of origin.

7. The method of claim 1 wherein the seismic signals are acquired from an array of seismic sensors deployed near the Earth's surface.

8. The method of claim 1 wherein the at least one seismic event and the at least one other seismic event are generated by pumping fluid into a subsurface formation.

9. A method for seismic evaluation of the Earth's subsurface, comprising:
deploying a plurality of seismic sensors proximate a volume of the Earth's subsurface to be evaluated;
detecting seismic signals from each of the sensors for a selected time interval;
determining presence of at least one seismic event in the seismic signals corresponding to each of the seismic sensors;
selecting a correlation window from each of the seismic signals, each correlation window having a selected time interval including an arrival time of the at least one seismic event in each seismic signal;
correlating each window to the respective seismic signal between a first selected time and a second selected time; and
determining presence of at least one other seismic event in the seismic signals from a result of the correlating.

10. The method of claim 9 wherein the determining presence of the at least one seismic event comprises selecting signal amplitude above a selected threshold in each of the seismic signals and determining whether arrival time of events above the selected threshold correspond to normal moveout of seismic energy.

11. The method of claim 9 further comprising determining a spatial origin of the at least one seismic event and the at least one other seismic event.

12. The method of claim 9 further comprising determining a time of origin of the at least one seismic event and the at least one other seismic event.

13. The method of claim 9 wherein the at least one seismic event and the at least one other seismic event are spatially related.

14. The method of claim 9 wherein the at least one seismic event and the at least one other seismic event are related in mechanism of origin.

15. The method of claim 9 wherein the seismic signals are acquired from an array of seismic sensor deployed near the Earth's surface.

16. The method of claim 9 wherein the at least one seismic event and the at least one other seismic event are generated by pumping fluid into a subsurface formation.

17. The method of claim 9 where at least one event is perforation shot.

18. The method of claim 9 wherein the at least one seismic event and the at least one other seismic event are generated by reservoir subsidence

19. The method of claim 9 wherein the at least one seismic event and the at least one other seismic event are generated by casing failure in a subsurface formation.
